(19) United States
(12) Patent Application Publication
(10) Pub. No.: US 2026/0093766 A1
(43) Pub. Date: Apr. 2, 2026

(54) AUTOMATIC VALIDATION OF UI FUNDAMENTALS TO ADHERE BRAND GUIDELINES AND ACCESSIBILITY

(71) Applicant: Dell Products L.P., Round Rock, TX (US)

(72) Inventors: Dev Kathuria, Greater Noida (IN); David Sydow, Merrimack, NH (US); Abhishek Mishra, Bangalore (IN); Vivek Bhargava, Bangalore (IN)

(73) Assignee: Dell Products L.P., Round Rock, TX (US)

(21) Appl. No.: 18/904,282

(22) Filed: Oct. 2, 2024

(51) Int. Cl. G06F 16/958

(52) U.S. Cl. CPC G06F 16/958

(57) ABSTRACT

Methods, system, and non-transitory processor-readable storage medium for UI design kit approval system are provided herein. An example method includes receiving, by a Continuous Integration/Continuous Delivery (CI/CD) pipeline runner system, a configuration interface defining User Interface (UI) design standards validation parameters for source code. The UI design kit approval system scans the source code to validate UI design standards associated with the source code using the configuration interface. The configuration interface is received by the UI design kit approval system via a UI design approval integration interface that integrates with the CI/CD pipeline runner system. The UI design kit approval system generates a UI design standards validation report indicating a compliance assessment of UI design standards associated with the source code.

### FIELD

The field relates generally to validating user interface components on a web page.

### BACKGROUND

Companies have many applications that are released on a periodical basis into production and are made available to their customers and employees. Before going to production, all the development teams involved in the development of the application should be compliant with user interface fundamentals, while at the same time, adhering to design and brand guidelines along with accessibility standards.

### SUMMARY

Illustrative embodiments provide techniques for implementing a UI design kit approval system in a storage system. For example, illustrative embodiments receive, by a Continuous Integration/Continuous Delivery (CI/CD) pipeline runner system, a configuration interface defining User Interface (UI) design standards validation parameters for source code. A UI design kit approval system scans the source code to validate UI design standards associated with the source code using the configuration interface, where the configuration interface is received by the UI design kit approval system via a UI design approval integration interface that integrates with the CI/CD pipeline runner system. The UI design kit approval system generates a UI design standards validation report indicating a compliance assessment of UI design standards associated with the source code. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a UI design kit approval system, in an illustrative embodiment.

FIG. 2 shows a UI design kit approval system, in an illustrative embodiment.

FIG. 3 shows a flow diagram of a process for a UI design kit approval system, in an illustrative embodiment.

FIG. 4 shows an outline of the validation performed by the UI design kit approval system, in an illustrative embodiment.

FIG. 5 illustrates example UI validation parameters defined in YAML format, in an illustrative embodiment.

FIG. 6 illustrates a sample YAML file, in an illustrative embodiment.

FIG. 7 illustrates example parameters and their respective values in the UI design standards validation report, in an illustrative embodiment.

FIG. 8 illustrates an example UI design standards validation report containing failed validation assessments, in an example embodiment.

FIG. 9 illustrates an example UI design standards validation report containing passed validation assessments, in an example embodiment.

FIG. 10 illustrates possible invocation of the UI design kit approval system within the CI/CD pipeline runner system, in an example embodiment.

FIGS. 11 and 12 show examples of processing platforms that may be utilized to implement at least a portion of a UI design kit approval system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a UI design kit approval system, which technique may be used to receive, by a Continuous Integration/Continuous Delivery (CI/CD) pipeline runner system, a configuration interface defining User Interface (UI) design standards validation parameters for source code. A UI design kit approval system scans the source code to validate UI design standards associated with the source code using the configuration interface, where the configuration interface is received by the UI design kit approval system via a UI design approval integration interface that integrates with the CI/CD pipeline runner system. The UI design kit approval system generates a UI design standards validation report indicating a compliance assessment of UI design standards associated with the source code.

There typically is a long process for validation of software applications across various development teams before the software is ready for production deployment. The last step of the process is where the UI is manually validated against preset company design guidelines.

Conventional technologies that manually validate UI standards result in a time-consuming effort requiring significant efforts of team members before the software is ready for production, for example, testing software for various accessibility standards, pixel perfect responsiveness, and design and brand compliance for each screen size. Conventional technologies that manually validate UI standards can be unreliable and lack precision. For example, manual validation can overlook the subtleties that may escape the human eye, such as specific color codes, precise typographical alignments, pixel-perfect icon placements, component spacings, and other minor but significant design elements. This causes visual inconsistencies or discrepancies in the software that leads to delays in the go-to-market process and ultimately leads to delay in the software's release-cycle. Conventional technologies that use manual validation run the risk of not complying with the UI standards set by the branding and compliance team and delaying the release of the software; this can result in failing to meet the production deadlines. Conventional technologies for validating UI design standards delay the development cycle and turnaround time for resolution for noncompliance assets and code. Conventional technologies for validating UI design standards increase the cost of software production by increasing the iterations required within the development cycle to manually validate the UI standards for the software. Conventional technologies that use manual validation may miss important patches or feature releases.

By contrast, in at least some implementations in accordance with the current technique as described herein, UI design standards are validated by receiving, by a Continuous Integration/Continuous Delivery (CI/CD) pipeline runner system, a configuration interface defining User Interface (UI) design standards validation parameters for source code. A UI design kit approval system scans the source code to validate UI design standards associated with the source code using the configuration interface, where the configuration interface is received by the UI design kit approval system via a UI design approval integration interface that integrates with the CI/CD pipeline runner system. The UI design kit approval system generates a UI design standards validation report indicating a compliance assessment of UI design standards associated with the source code.

Thus, a goal of the current technique is to provide a method and a system for providing a UI design kit approval system that validates UI design standards. Another goal is to speed up the development cycle and turnaround time for resolution for noncompliance assets and code by enabling an automated validation at Visual level and Code level. Another goal is to provide a smart integration of automation techniques to validate UI fundamentals to adhere brand guidelines and accessibility standards, validating any kind of application that reaches the governing body against a preset guideline of branding and providing approval from a visual design and user experience standpoint. Another goal is to optimize the overall process and reduce the delay caused by the manual process and scan through the source code/working application to ensure the components utilized adhere to the design standards of the organization. Another goal is to ensure that all enhancements, whether an important patch or feature release are completed in the development sprint. Another goal is to integrate with existing DevOps/TechOps CI/CD pipelines to replace manual validation of UI/UX elements with automated validation at visual, code and content level to offer continuous verification. Yet another goal is to reduce the UI design/branding approval workflow to a fraction of its previous time, for example, from 1 to 2 weeks to 1 to 2 hours.

In at least some implementations in accordance with the current technique described herein, the use of a UI design kit approval system can provide one or more of the following advantages: providing a method and a system for providing a UI design kit approval system that validates UI design standards, optimizing the development cycle and turnaround time for resolution for noncompliance assets and code by enabling an automated validation at a visual level and a code level, providing a smart integration of automation techniques to validate UI fundamentals to adhere brand guidelines and accessibility standards, optimizing the overall process and reducing the delay caused by the manual process and scanning through the source code/working application to ensure the components utilized adhere to the design standards of the organization, ensuring that all enhancements, whether an important patch or feature release are completed in the development sprint, integrating with existing DevOps/TechOps CI/CD pipelines to replace manual validation of UI/UX elements with automated validation at visual, code, and content level to offer continuous verification, and reducing the UI design/branding approval workflow to a fraction of its previous time.

In contrast to conventional technologies, in at least some implementations in accordance with the current technique as described herein, UI design standards are validated by receiving, by a Continuous Integration/Continuous Delivery (CI/CD) pipeline runner system, a configuration interface defining User Interface (UI) design standards validation parameters for source code. A UI design kit approval system scans the source code to validate UI design standards associated with the source code using the configuration interface, where the configuration interface is received by the UI design kit approval system via a UI design approval integration interface that integrates with the CI/CD pipeline runner system. The UI design kit approval system generates a UI design standards validation report indicating a compliance assessment of UI design standards associated with the source code.

In an example embodiment of the current technique, the UI design kit approval system transmits the validated source code to a build stage associated with the CI/CD pipeline runner system.

In an example embodiment of the current technique, the UI design kit approval system validates a compiled version of the source code after a build stage associated with the CI/CD pipeline runner system.

In an example embodiment of the current technique, the configuration interface defines UI validation parameters, where the UI validation parameters comprise valid colors, component spacing, valid icons, component layouts, legal links, valid licenses, and accessibility standards, and where a. yaml file comprises the UI validation parameters.

In an example embodiment of the current technique, the UI design standards are modified by modifying the UI validation parameters in the .yaml file without impacting execution of the CI/CD pipeline runner system.

In an example embodiment of the current technique, a visual validation module performs a visual validation validating at least one of valid colors, UI components, component spacing, valid icons, UI component layouts, typography, screen size layout, and legal links within the source code, where the UI design kit approval system comprises the visual validation module.

In an example embodiment of the current technique, the visual validation module performs the visual validation on a plurality of UI screen sizes.

In an example embodiment of the current technique, a static code analysis module performs a static code analysis, by a static code analysis module analyzing at least one of license validation and accessibility standards compliance within the source code, where the UI design kit approval system comprises the static code analysis module.

In an example embodiment of the current technique, the static code analysis module assesses usage of design tokens across the source code.

In an example embodiment of the current technique, the static code analysis module assesses usage of constant design attributes from a brand palette across the source code.

In an example embodiment of the current technique, the static code analysis module assesses usage of prebuilt helper classes in a framework associated with the source code.

In an example embodiment of the current technique, the static code analysis module validates third-party components.

In an example embodiment of the current technique, the static code analysis module verifies unknown libraries for accessibility standards.

In an example embodiment of the current technique, the UI design kit approval system generates the UI design standards validation report for each user interface page scanned.

In an example embodiment of the current technique, the UI design kit approval system generates a validation report .yaml file for each UI design standards validation report.

In an example embodiment of the current technique, the UI design standards validation report comprises at least one parameter of valid colors, component spacing, valid icons, component layouts, legal links, valid licenses, and accessibility standards.

In an example embodiment of the current technique, the UI design standards validation report comprises a list of invalid licenses detected.

In an example embodiment of the current technique, the UI design standards validation report comprises a list of missing accessibility standards libraries.

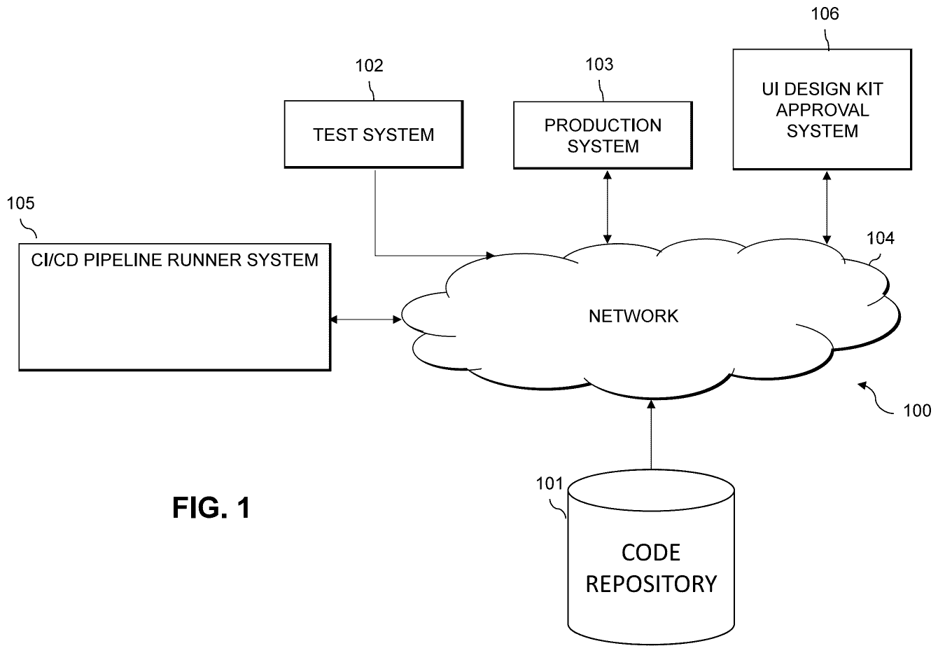

FIG. 1 shows a computer network (also referred to herein as an information processing system) 100 configured in accordance with an illustrative embodiment. The computer network 100 comprises a Continuous Integration/Continuous Delivery (CI/CD) pipeline system 105, a test system 102, a production system 103, a user interface (UI) design kit approval system 106, and a code repository 101. In an example embodiment, CI/CD as that term is used herein refers generally to continuous integration, continuous deployment and/or continuous delivery. Such functions or portions thereof are considered to be examples of a “software development process” as that term is broadly used herein. A wide variety of other types of software development processes may be utilized in other embodiments, illustratively relating to integration, deployment and/or other aspects of software development for one or more of the source code that is executed on the test system 102, production system 103, or other systems. The CI/CD pipeline system 105, test system 102, production system 103, UI design kit approval system 106, and code repository 101 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a UI design kit approval system 106 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the CI/CD pipeline system 105, test system 102, production system 103, UI design kit approval system 106, and code repository 101 may comprise, for example, servers and/or portions of one or more server systems, as well as devices such as mobile telephones, laptop computers, tablet computers, desktop computers or other types of computing devices. Such devices are examples of what are more generally referred to herein as “processing devices. ” Some of these processing devices are also generally referred to herein as “computers. ”

The CI/CD pipeline system 105, test system 102, production system 103, user interface (UI) design kit approval system 106, and code repository 101 in some embodiments comprise respective computers associated with a particular company, organization or other enterprise. In addition, at least portions of the computer network 100 may also be referred to herein as collectively comprising an “enterprise network. ” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the UI design kit approval system 106 are one or more input-output devices, which illustratively comprise keyboards, displays or other types of input-output devices in any combination. Such input-output devices can be used, for example, to support one or more user interfaces to the UI design kit approval system 106, as well as to support communication between the UI design kit approval system 106 and other related systems and devices not explicitly shown. For example, a dashboard may be provided for a user to view a progression of the execution of the UI design kit approval system 106. One or more input-output devices may also be associated with any of the CI/CD pipeline system 105, test system 102, production system 103, user interface (UI) design kit approval system 106, and code repository 101.

Additionally, the UI design kit approval system 106 in the FIG. 1 embodiment is assumed to be implemented using at least one processing device. Each such processing device generally comprises at least one processor and an associated memory, and implements one or more functional modules for controlling certain features of the UI design kit approval system 106.

More particularly, the UI design kit approval system 106 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture”as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the UI design kit approval system 106 to communicate over the network 104 with the CI/CD pipeline system 105, test system 102, production system 103, UI design kit approval system 106, and code repository 101 and illustratively comprises one or more conventional transceivers.

A UI design kit approval system 106 may be implemented at least in part in the form of software that is stored in memory and executed by a processor, and may reside in any processing device. The UI design kit approval system 106 may be a standalone plugin that may be included within a processing device.

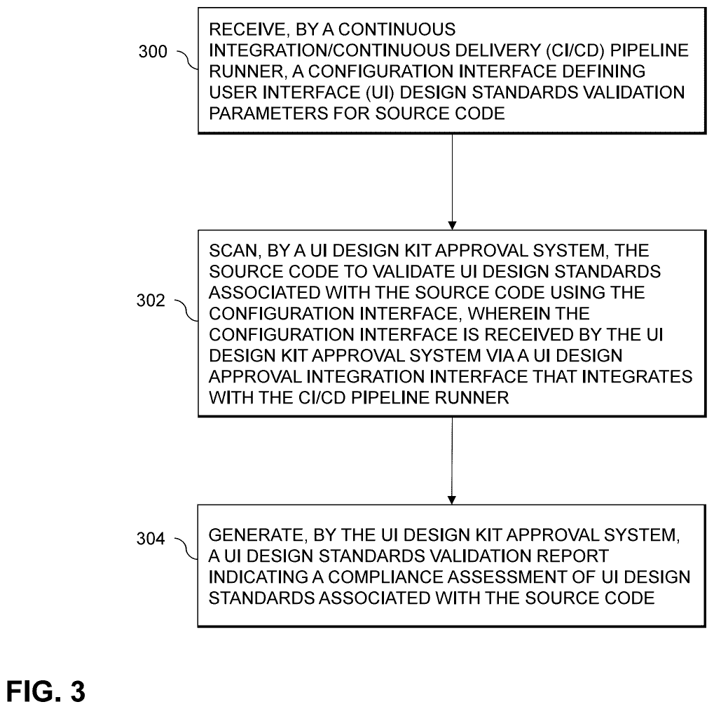

It is to be understood that the particular set of elements shown in FIG. 1 for UI design kit approval system 106 involving the CI/CD pipeline system 105, test system 102, production system 103, UI design kit approval system 106, and code repository 101 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the UI design kit approval system 106 can be on and/or part of the same processing platform. An exemplary process of UI design kit approval system 106 in computer network 100 will be described in more detail with reference to, for example, the flow diagram of FIG. 3.

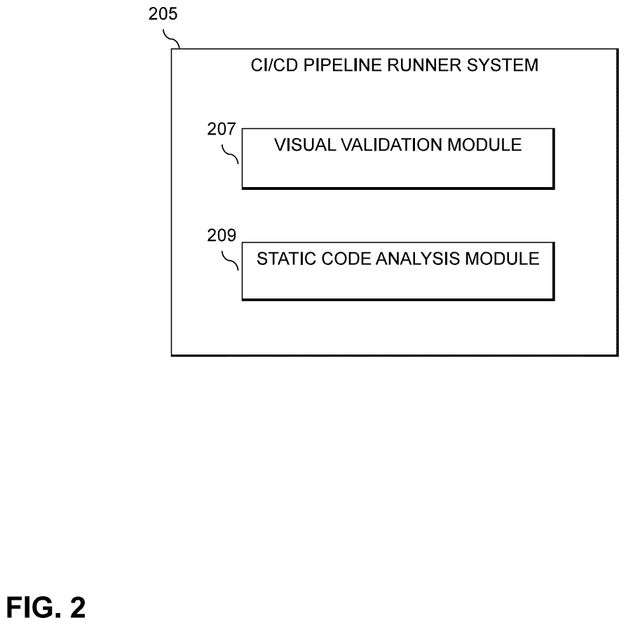

FIG. 2 illustrates a UI design kit approval system 205 comprising a visual validation module 207 and a static code analysis module 209.

FIG. 3 is a flow diagram of a process for execution of the UI design kit approval system 106 in an illustrative embodiment. It is to be understood that this particular process is only an example, and additional or alternative processes can be carried out in other embodiments.

At 300, a CI/CD pipeline runner system 105 receives a configuration interface defining User Interface (UI) design standards validation parameters for source code. A CI/CD pipeline runner system 105 automates a software delivery process, and typically comprises a set of automated processes and tools that allow developers and an operations team to work together to generate and deploy application software code to a production environment. A CI/CD pipeline runner system 105 may comprise a specified set of elements and/or environments. Such elements and/or environments may be added or removed from the CI/CD pipeline runner system 105, for example, based at least in part on the software and/or compliance requirements. A CI/CD pipeline runner system 105 typically comprises one or more quality control gates to ensure that software code does not get released to a production environment without satisfying a number of predefined testing and/or quality requirements. For example, a quality control gate may specify that software code should compile without errors and that all unit tests and functional user interface tests must pass.

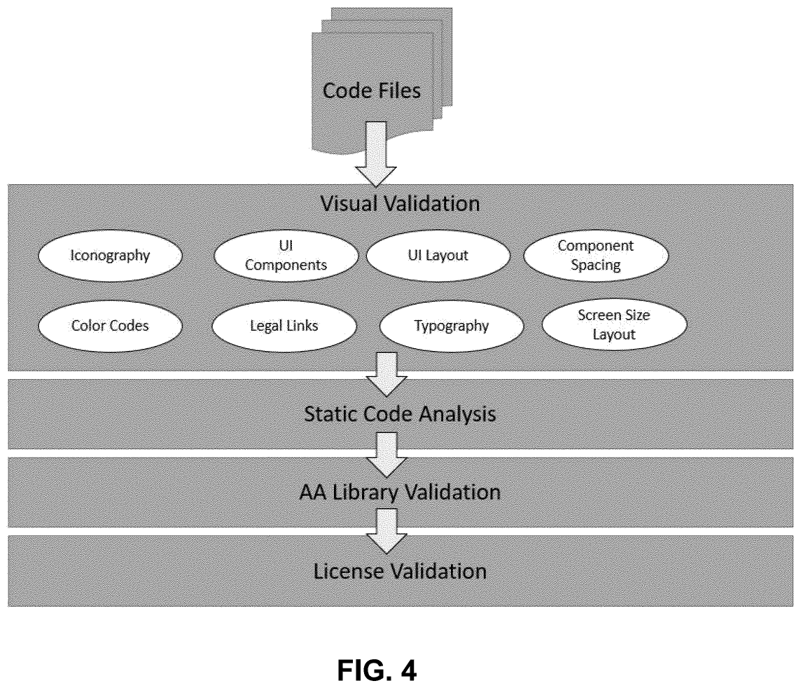

The CI/CD pipeline runner system 105 may comprise, for example, a commercially-available CI/CD system such as Jenkins, Jira, and/or other types of DevOps tools, suitably modified in the manner disclosed herein to provide software development processes utilizing the UI design kit approval system 106 to validate UI design standards. FIG. 4 shows example validation analysis performed by the UI design kit approval system 106 to validate various components. In an example embodiment, the code files (i.e., the source code) are retrieved from the code repository 101.

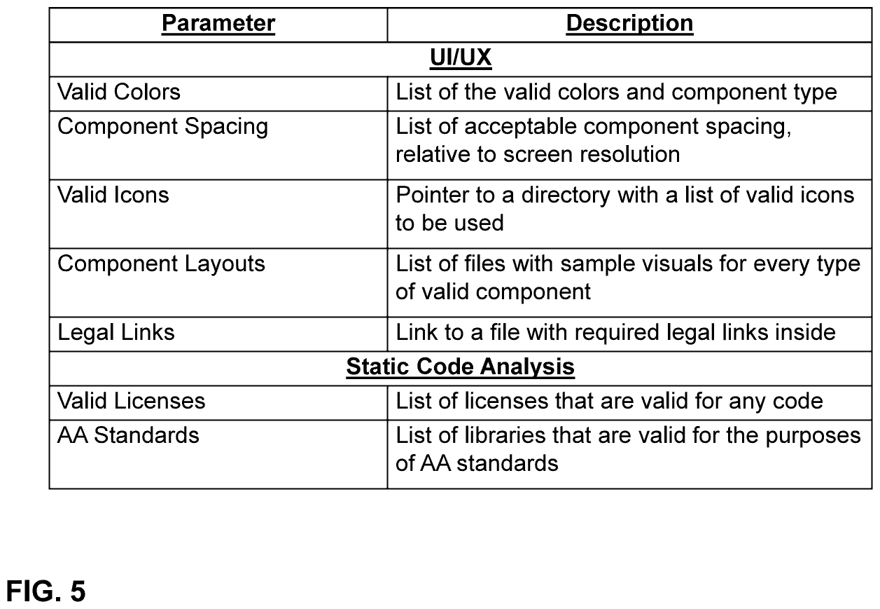

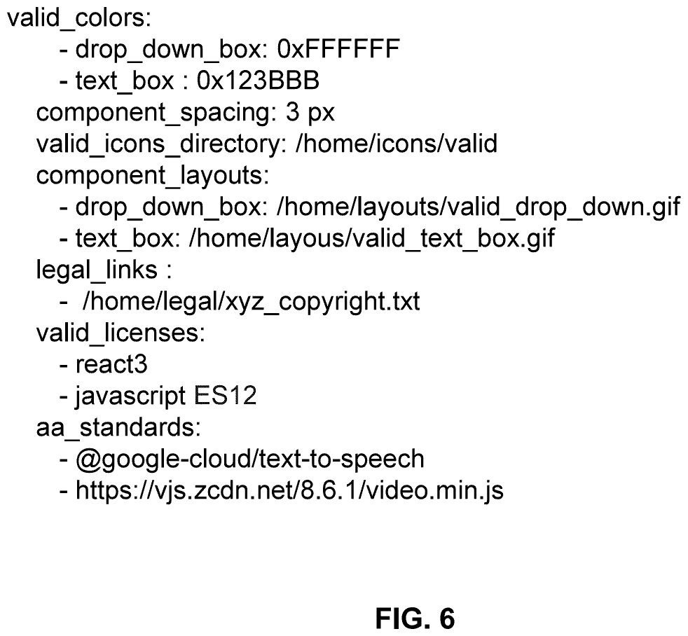

In an example embodiment, the configuration interface defines UI validation parameters, for example, valid colors, component spacing, valid icons, component layouts, legal links, valid licenses, and accessibility standards. In an example embodiment, the UI validation parameters are mapped in a .yaml file to be read by the CI/CD pipeline runner system 105. FIG. 5 illustrates example UI validation parameters defined in “YAML Ain't Markup Language” (YAML) format. In an example embodiment, the UI design standards are modified by modifying the UI validation parameters in the .yaml file without impacting execution of the CI/CD pipeline runner system 105. FIG. 6 illustrates a sample YAML file that is consumed by the CI/CD pipeline runner system 105 when validating source code using the UI design kit approval system 106. In an example embodiment, a structural similarity index is used to compute the difference between two images for the “components layout”parameter.

At 302, a UI design kit approval system 106 scans the source code to validate UI design standards associated with the source code using the configuration interface. In an example embodiment, the configuration interface is received by the UI design kit approval system 106 via a UI design approval integration interface that integrates with the CI/CD pipeline runner system 105. In an example embodiment, the CI/CD pipeline runner system 105 invokes the UI design kit approval system 106 at pre-set intervals. In another example embodiment, the CI/CD pipeline runner system 105 invokes the UI design kit approval system 106 on-demand as changes are made by the CI/CD pipeline runner system 105.

In an example embodiment, a visual validation module 207 performs a visual validation to validate at least one of valid colors, UI components, component spacing, valid icons, UI component layouts, typography, screen size layout, and legal links within the source code. In an example embodiment, the UI design kit approval system 106 comprises the visual validation module 207. For example, the visual validation module 207 validates iconography and UI components, such as dropdown menus, form fields, card views, list views, etc. In an example embodiment, the visual validation module 207 validates UI layout, such as tabs, segmented control, navigation menus, etc. In an example embodiment, the visual validation module 207 validates component spacing, for example, a design standard may specify that components have spacing in a multiple of 4 pixels, etc. In an example embodiment, the visual validation module 207 validates mandatory legal links, such as “Terms of Use” and “Privacy Policy”. In an example embodiment, the visual validation module 207 validates accessibility standards, color codes and typography. In an example embodiment, the visual validation module 207 performs a visual validation on all the above on a plurality of UI screen sizes, meaning all possible screen sizes.

In an example embodiment, a static code analysis module 209 performs a static code analysis to analyze at least one of license validation and accessibility standards compliance within the source code. In an example embodiment, the UI design kit approval system 106 comprises the static code analysis module 209. In an example embodiment, the static code analysis module 209 identifies best practices for design standards. In an example embodiment, the static code analysis module 209 assesses usage of design tokens across the source code, such as constant design attributes like colors, typography, etc. In an example embodiment, the static code analysis module 209 assesses usage of constant design attributes from a brand palette across the source code. In an example embodiment, the static code analysis module 209 assesses usage of prebuilt helper classes in a framework associated with the source code, for example helper classes for spacing, layouts, responsiveness, recommended cascading style sheets (CSS) code, etc. In an example embodiment, the static code analysis module 209 validates third-party components. For example, if there is a new third-party component, the static code analysis module 209 validates that the new third-party component is not a denied library. In an example embodiment, the static code analysis module 209 verifies unknown libraries for accessibility standards. In an example embodiment, the static code analysis module 209 verifies libraries and supporting packages which can bring a different experience and enhance performance in application code, to verify that the libraries and supporting packages are compliant with organization standards.

At 304, the UI design kit approval system 106 generates a UI design standards validation report indicating a compliance assessment of UI design standards associated with the source code. In an example embodiment, the UI design kit approval system 106 generates the UI design standards validation report in YAML format, with a single YAML file generated for each individual UI page scanned by the UI design kit approval system 106. In an example embodiment, the UI design kit approval system 106 generates a UI design standards validation report YAML file for each UI design standards validation report.

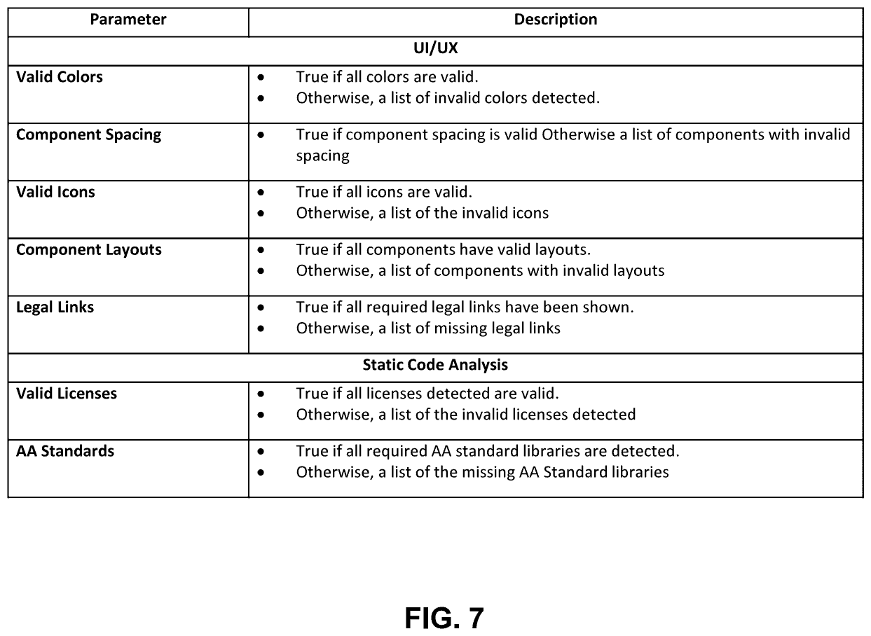

In an example embodiment, the UI design standards validation report comprises at least one parameter of valid colors, component spacing, valid icons, component layouts, legal links, valid licenses, and accessibility standards. FIG. 7 illustrates example parameters and their respective values in the UI design standards validation report.

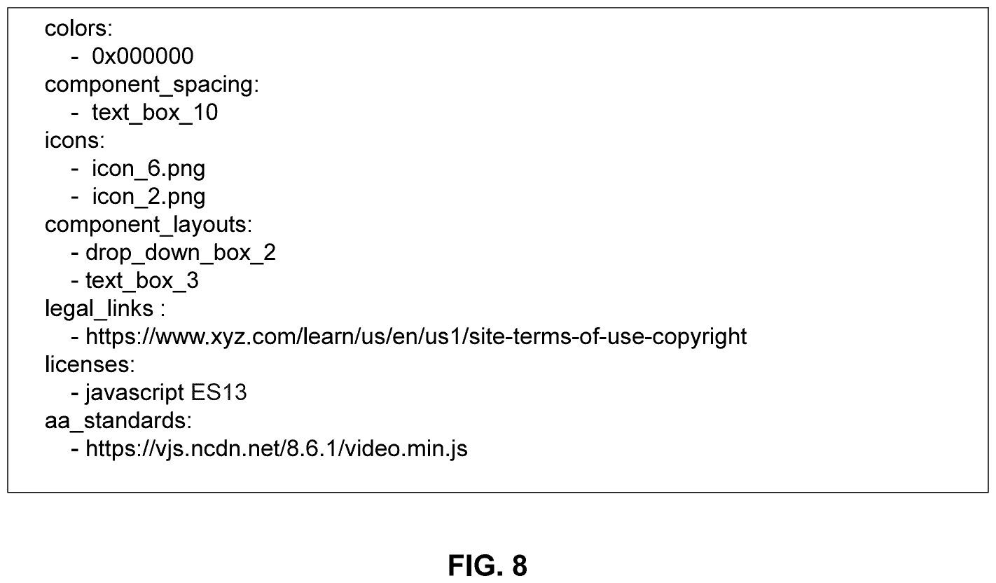

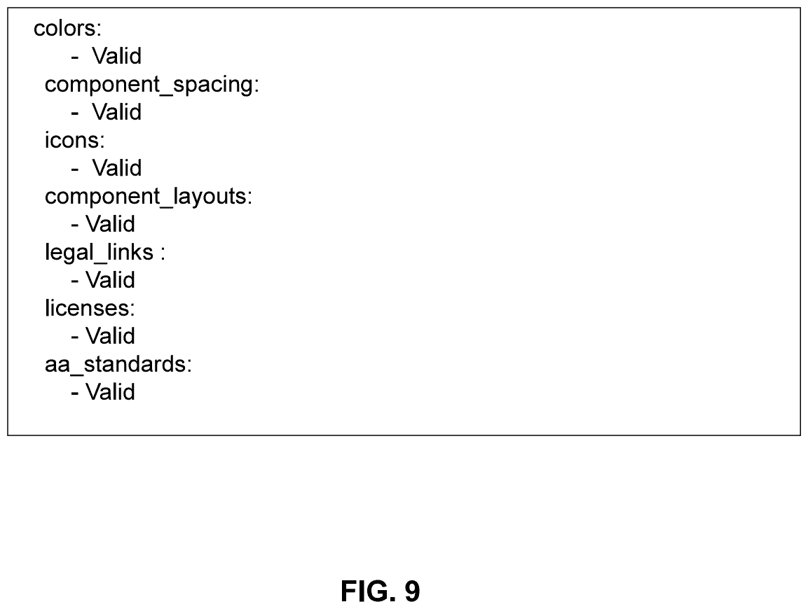

In an example embodiment, the UI design standards validation report comprises a list of invalid licenses detected. In an example embodiment, the UI design standards validation report comprises a list of missing accessibility standards libraries. FIG. 8 illustrates an example UI design standards validation report containing failed validation assessments and FIG. 9 illustrates an example UI design standards validation report containing passed validation assessments.

In an example embodiment, the UI design kit approval system 106 transmits the validated source code to a build stage associated with the CI/CD pipeline runner system 105. In an example embodiment, the UI design kit approval system 106 is invoked within the CI/CD pipeline runner system 105 early in the pipeline before the build stage. The UI design kit approval system 106 validates the source code using the parameters in the. YAML file. After the UI design kit approval system 106 complete the validation process, the validated source code is transmitted from the UI design kit approval system 106 to the build stage in the CI/CD pipeline runner system 105.

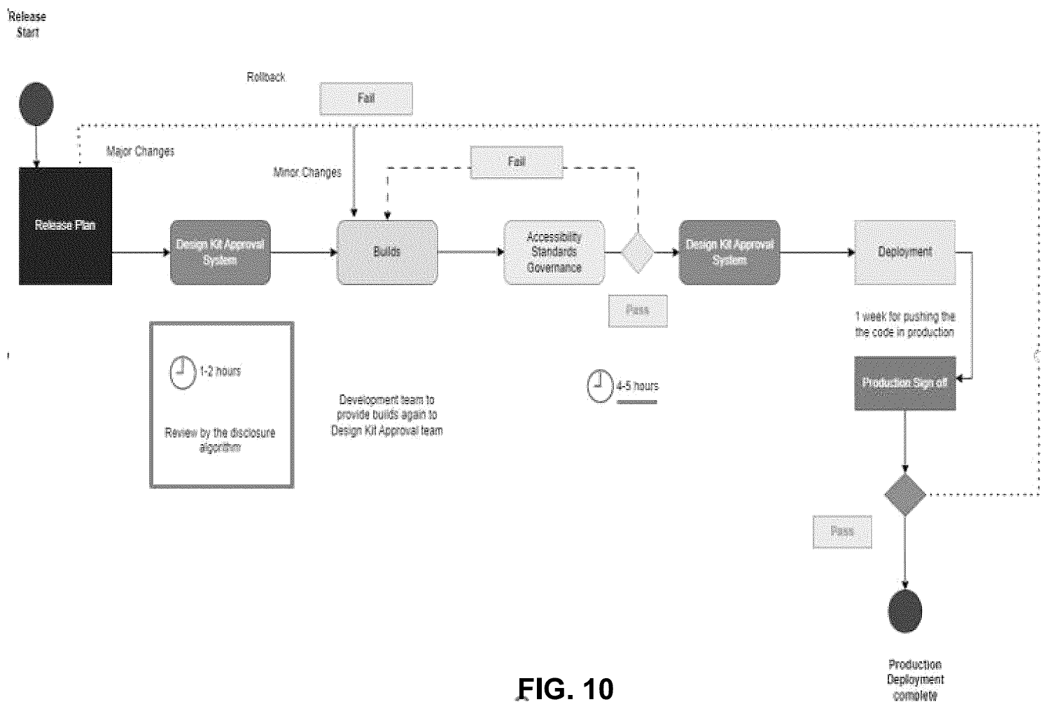

In an example embodiment, the UI design kit approval system 106 validates a compiled version of the source code after a build stage associated with the CI/CD pipeline runner system 105. In this example embodiment, the UI design kit approval system 106 validates for any other non-compliant element in the UI, potentially caused by, for example, dependency updates or environmental differences. Dependency updates can be updates to libraries or dependencies which can cause compatibility issues or introduce new failures. Environmental differences can be discrepancies between development, staging and/or production environments (such as the production system 103) that can lead to issues that appear only in certain environments. In an example embodiment, the UI design kit approval system 106 evaluates the compiled source code to ensure that any non-compliant elements introduced during the build process or due to environmental factors are identified and addressed. FIG. 10 illustrates the CI/CD pipeline runner system 105 along with the UI design kit approval system 106 invoked, in one example embodiment, before the build stage and in another example embodiment, after the build stage.

Accordingly, the particular processing operations and other functionality described in conjunction with the flow diagram of FIG. 3 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to provide a method and a system for providing a UI design kit approval system that validates UI design standards. These and other embodiments can effectively improve UI design standards validation relative to conventional approaches. For example, embodiments disclosed herein accelerate the development cycle and turnaround time for resolution for noncompliance assets and code by enabling an automated validation at Visual level and Code level. Embodiments disclosed herein provide a smart integration of automation techniques to validate UI fundamentals to adhere brand guidelines and accessibility standards, validating any kind of application that reaches the governing body against a preset guideline of branding and providing approval from a visual design and user experience standpoint. Embodiments disclosed herein optimize the overall process and reduce the delay caused by the manual process and scan through the source code/working application to ensure the components utilized adhere to the design standards of the organization. Embodiments disclosed herein ensure that all enhancements, whether an important patch or feature release are completed in the development sprint. Embodiments disclosed herein integrate with existing DevOps/TechOps CI/CD pipelines to replace manual validation of UI/UX elements with automated validation at visual, code and content level to offer continuous verification. Embodiments disclosed herein reduce the UI design/branding approval workflow to a fraction of its previous time, for example, from 1 to 2 weeks to 1 to 2 hours.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

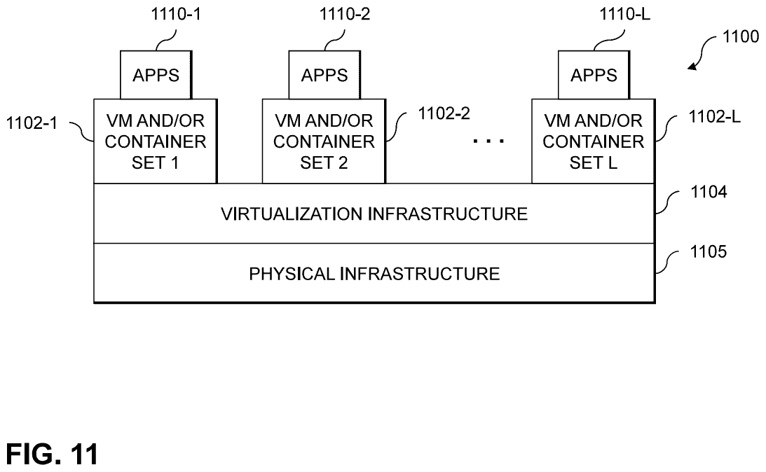

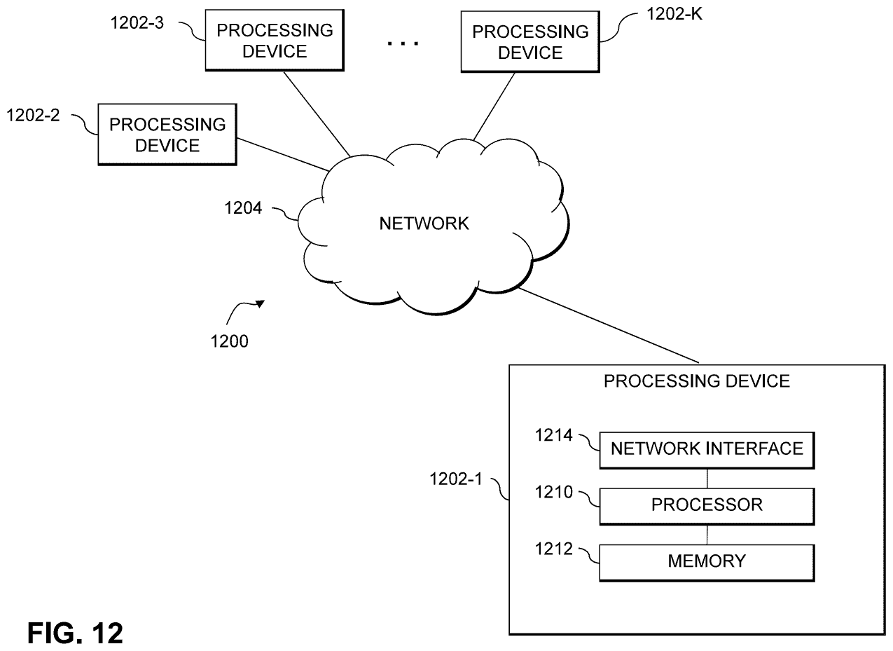

Illustrative embodiments of processing platforms will now be described in greater detail with reference to FIGS. 11 and 12. Although described in the context of the information processing system 100, these platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that are utilized to implement at least a portion of the information processing system 100. The cloud infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 comprise respective VMs, respective sets of one or more containers, or respective sets of one or more containers running in VMs. In some implementations of the FIG. 11 embodiment, the VMs/container sets 1102 comprise respective VMs implemented using virtualization infrastructure 1104 that comprises at least one hypervisor.

A hypervisor platform may be used to implement a hypervisor within the virtualization infrastructure 1104, where the hypervisor platform has an associated virtual infrastructure management system. The underlying physical machines comprise one or more distributed processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device. ” The cloud infrastructure 1100 shown in FIG. 11 may represent at least a portion of one processing platform. Another example of such a processing platform is processing platform 1200 shown in FIG. 12.

The processing platform 1200 in this embodiment comprises a portion of the information processing system 100 and includes a plurality of processing devices, denoted 1202-1, 1202-2, 1202-3, . . . 1202-K, which communicate with one another over a network 1204.

The network 1204 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1202-1 in the processing platform 1200 comprises a processor 1210 coupled to a memory 1212.

The processor 1210 comprises a microprocessor, a microcontroller, an application-specific integrated circuit (ASIC), a field-programmable gate array (FPGA) or other type of processing circuitry, as well as portions or combinations of such circuitry elements.

The memory 1212 comprises random access memory (RAM), read-only memory (ROM) or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving, by a Continuous Integration/Continuous Delivery (CI/CD) pipeline runner system, a configuration interface defining User Interface (UI) design standards validation parameters for source code;
scanning, by a UI design kit approval system, the source code to validate UI design standards associated with the source code using the configuration interface, wherein the configuration interface is received by the UI design kit approval system via a UI design approval integration interface that integrates with the CI/CD pipeline runner system; and
generating, by the UI design kit approval system, a UI design standards validation report indicating a compliance assessment of UI design standards associated with the source code, wherein the method is performed by at least one processing device comprising a processor coupled to a memory.

2. The method of claim 1 further comprising:
transmitting the validated source code to a build stage associated with the CI/CD pipeline runner system.

3. The method of claim 1 further comprising:
validating a compiled version of the source code after a build stage associated with the CI/CD pipeline runner system.

4. The method of claim 1 wherein the configuration interface defines UI validation parameters, wherein the UI validation parameters comprise valid colors, component spacing, valid icons, component layouts, legal links, valid licenses, and accessibility standards, and wherein a .yaml file comprises the UI validation parameters.

5. The method of claim 4 wherein the UI design standards are modified by modifying the UI validation parameters in the .yaml file without impacting execution of the CI/CD pipeline runner system.

6. The method of claim 1 wherein scanning, by the UI design kit approval system, the source code to validate UI design standards comprises:
performing a visual validation, by a visual validation module, wherein the visual validation module validates at least one of valid colors, UI components, component spacing, valid icons, UI component layouts, typography, screen size layout, and legal links within the source code, wherein the UI design kit approval system comprises the visual validation module.

7. The method of claim 6 wherein the visual validation module performs the visual validation on a plurality of UI screen sizes.

8. The method of claim 1 wherein scanning, by the UI design kit approval system, the source code to validate UI design standards comprises:
performing a static code analysis, by a static code analysis module, wherein the static code analysis module analyzes at least one of license validation and accessibility standards compliance within the source code,, wherein the UI design kit approval system comprises the code analysis module.

9. The method of claim 8 wherein the static code analysis module assesses usage of design tokens across the source code.

10. The method of claim 8 wherein the static code analysis module assesses usage of constant design attributes from a brand palette across the source code.

11. The method of claim 8 wherein the static code analysis module assesses usage of prebuilt helper classes in a framework associated with the source code.

12. The method of claim 8 wherein the static code analysis module validates third-party components.

13. The method of claim 8 wherein the static code analysis module verifies unknown libraries for accessibility standards.

14. The method of claim 1 wherein generating, by the UI design kit approval system, the UI design standards validation report comprises:
generating the UI design standards validation report for each user interface page scanned.

15. The method of claim 1 wherein generating, by the UI design kit approval system, the UI design standards validation report comprises:
generating a validation report .yaml file for each UI design standards validation report.

16. The method of claim 1 wherein the UI design standards validation report comprises at least one parameter of valid colors, component spacing, valid icons, component layouts, legal links, valid licenses, and accessibility standards.

17. The method of claim 1 wherein the UI design standards validation report comprises a list of invalid licenses detected.

18. The method of claim 1 wherein the UI design standards validation report comprises a list of missing accessibility standards libraries.

19. A system comprising:
at least one processing device comprising a processor coupled to a memory;
the at least one processing device being configured:
to receive, by a Continuous Integration/Continuous Delivery (CI/CD) pipeline runner system, a configuration interface defining User Interface (UI) design standards validation parameters for source code;
to scan, by a UI design kit approval system, the source code to validate UI design standards associated with the source code using the configuration interface, wherein the configuration interface is received by the UI design kit approval system via a UI design approval integration interface that integrates with the CI/CD pipeline runner system; and
to generate, by the UI design kit approval system, a UI design standards validation report indicating a compliance assessment of UI design standards associated with the source code.

20. A computer program product comprising a non-transitory processor-readable storage medium having stored therein program code of one or more software programs, wherein the program code when executed by at least one processing device causes said at least one processing device:
to receive, by a Continuous Integration/Continuous Delivery (CI/CD) pipeline runner system, a configuration interface defining User Interface (UI) design standards validation parameters for source code;
to scan, by a UI design kit approval system, the source code to validate UI design standards associated with the source code using the configuration interface, wherein the configuration interface is received by the UI design kit approval system via a UI design approval integration interface that integrates with the CI/CD pipeline runner system; and
to generate, by the UI design kit approval system, a UI design standards validation report indicating a compliance assessment of UI design standards associated with the source code.
